(19) United States
(12) Patent Application Publication
(10) Pub. No.: US 2009/0137177 A1
(43) Pub. Date: May 28, 2009

(54) Oil Absorbent Blanket and Method for Manufacturing the Same

(76) Inventor: Johannes Cornelis Jonker, Capelle a/d IJssel (NL)

Correspondence Address: HARNESS, DICKEY & PIERCE, P.L.C., P.O. BOX 8910, RESTON, VA, 20195, US

(21) Appl. No.: 11/990,762

(22) PCT Filed: Aug. 22, 2006
(86) PCT No.: PCT/NL2006/050207

§ 371 Date: Feb. 21, 2008

(30) Foreign Application Priority Data
Aug. 22, 2005 (NL) 1029775

(51) Int. Cl. B32B 5/02; B29C 43/00

(52) U.S. Cl. 442/414; 264/320

(57) ABSTRACT

In one embodiment of the present application, a method is disclosed for manufacturing an oil absorbent blanket, wherein particles having a high oil absorption capacity are incorporated in a fibre structure. The blanket is a nonwoven blanket which is manufactured by the method including: arranging the fibres in a flat structure, in which the fibres extend substantially perpendicularly to the plane of the structure; adding the oil absorbent particles to the fibre material; rotating the fibres from the aforesaid perpendicular direction to a direction substantially parallel to the plane of the structure; and compressing the fibre structure, so that a coherent blanket is obtained.

The invention relates to a method for manufacturing an oil absorbent blanket, wherein particles having a high oil absorption capacity are incorporated in a fibre structure.

Such a blanket is described in DE-A-19726182. The blanket disclosed therein comprises a sandwich construction consisting of two layers of deep-pile textile, in which the pile sides of the two layers face towards each other and cellulose is provided between the piles of the textile. The manufacture of such a blanket is a complicated process, the blanket obtained is not very robust and has a limited oil absorption capacity. Also other blankets are known, in which blankets only a very limited amount of oil absorbent material can be incorporated, however, or from which part of the material (granules or powder) is lost prior to use upon movement of the blanket.

The object of the invention is to provide a simple method for manufacturing an inexpensive, reliable and strong oil absorbent blanket having a high oil absorption capacity, wherein any leakage of oil from the blanket after use thereof is minimised.

According to the invention, the blanket is a nonwoven blanket which is manufactured by carrying out the following steps: arranging the fibres in a flat structure, in which the fibres extend substantially perpendicularly to the plane of the structure; adding the oil absorbent particles to the fibre material; rotating the fibres from the aforesaid perpendicular direction to a direction substantially parallel to the plane of the structure; and compressing the fibre structure, so that a coherent blanket is obtained.

Preferably, the granules are made of polyurethane foam. Polyurethane foam is known as material which has a very high oil absorption capacity, as described inter alia in NL-A-7205232, and which be recovered from discarded refrigerators, for example. The granules preferably have a diameter of 1-4 mm, as a result of which the oil absorption capacity is increased. Furthermore, a high absorption capacity is obtained as a result of the non-woven nature of the blanket, since the oil can readily permeate therein, the fibre area is large and the polyurethane foam granules are well distributed. When this method according to the invention is used, hardly any raw materials are lost, if at all.

The fibres are preferably at least partially made of a synthetic material. The outer side of the fibres preferably has a lower melting point than the core of the fibres. The fibres are preferably made of polypropylene, and the outer side of the fibres is preferably made of copolymer polypropylene. Polyester is an alternative to polypropylene. The fibres preferably have a length of 20-80 mm, more preferably 40-60 mm.

Preferably, the blanket is heated during or after compression of the fibre structure, causing the outer side of the fibres and/or the granules to melt at least partially, to such an extent that the granules will adhere to the fibres. A good distribution of the granules and the fibres ensures that this fusing process will take place in an efficient manner with a minimal energy consumption.

The invention further relates to an oil absorbent blanket manufactured by using a method as described above.

Using the invention, a very strong blanket can be manufactured, which comprises more than 50 wt. % polyurethane and which has a high oil absorption capacity, therefore. In addition, there will be hardly any loss of polyurethane granules from the blanket prior to use, if at all.

The invention will now be explained in more detail by means of a description of an embodiment, in which reference is made to the figures, in which:

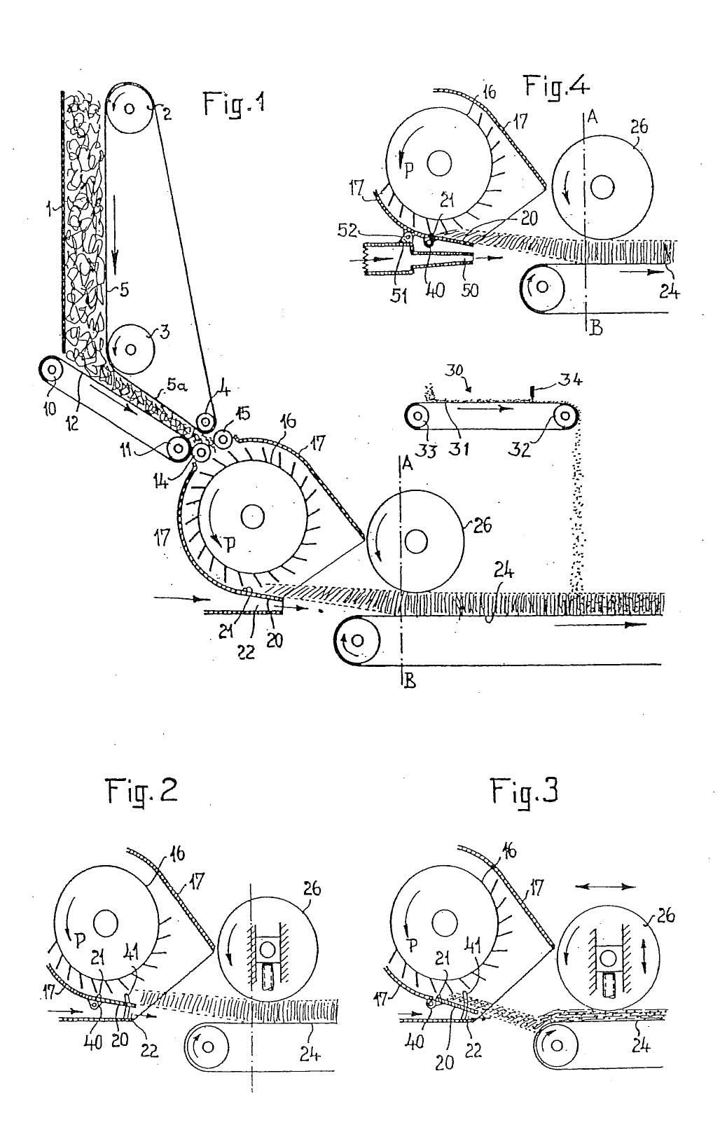

FIG. 1 is a side view of an embodiment of a device, in a first setting thereof, for carrying out a first step of the manufacture of the oil absorbent blanket;

FIG. 2 shows a detail of the device of FIG. 1;

FIG. 3 shows a detail of the device of FIG. 1, in another setting thereof, for carrying out a next step of the manufacture of the oil absorbent blanket;

FIG. 4 shows a detail of a side elevation of an alternative embodiment of the device.

According to this embodiment of the invention, an oil absorbent blanket is made from fibres of a synthetic material and oil absorbent granules.

The synthetic fibres may have a length of a few centimetres and consist of a core of polypropylene and an outer layer of copolymer polypropylene. The outer layer thus has a lower melting point than the core of the fibres. Preferably, the fibres have been subjected to a water repelling treatment.

The oil absorbent granules are polyurethane foam granules, which are obtained by pulverising polyurethane foam into granules having a diameter of 1-4 mm (preferably about 3 mm), (which granules may have been screened, if necessary). Such granules are known as a waste product obtained from the processing of PUR foam from refrigerators.

FIG. 1 shows a device for forming a fibre structure which, with the exception of the spreading device 30, is described in Austrian patent publication AT 205335 (as well as in the corresponding German patent publication DE 1122418, British patent publication GB 881523 and French patent publication FR 1195940) in the name of Dr Otto Angleitner.

The device comprises a vertical chute 1 via which the fibre material is supplied, said chute being bounded on the right-hand side by a supply belt 5, which runs over rollers 2, 3, 4 in the direction indicated by the arrow. In a first production step, the fibre material is carried between a downwardly sloping part 5a of the supply belt 5 and an opposite conveyor belt 12, which extends parallel thereto over rollers 10, 11, towards a pair of supply rollers 14, 15. The supply rollers 14, 15 are disposed slightly below the upper side of a pick-up roller 16, which rotates in the direction indicated by the arrow P in a housing 17. The pick-up roller 16 carries the material through the passage between the outer surface of the roller 16 and the housing 17 by means of the card clothing on the roller. The housing 17 terminates in an ejection lip 20 at a point near the lower part of the pick-up roller 16, which ejection lip extends from an ejection edge 21 of the housing in the direction of the line of intersection between a plane A-B (illustrated by the dotted line) and a conveyor belt 24. The ejection lip 20 at the same time forms an upper wall of a flat blow nozzle 22, which is connected to an air pump (not shown). By means of said air pump, a wide air flow can be blown with an adjustable force against the fibre material that is being ejected via the lip 20 by the pick-up roller. Said air flow is directed parallel to the direction in which the fibre material is ejected. To obtain a fibre structure, the material is pushed against a passage formed the plane A-B between the conveyor belt 24 and a rotating pressure roller 26.

The air flow may be generated by a fan or by a row of blow nozzles that expel compressed air into the blow nozzle 22. The density of the fibre structure can be adjusted by adapting the amount of air and the velocity of the air flow. The higher the velocity of the air flow, the higher the dynamic pressure on the passage in the plane A-B and the higher the fibre density in the structure being formed on the conveyor belt 24.

The lip 20 and the blow nozzle 22 have been adapted for pivoting movement about the ejection edge 21 by providing bearing bushes 40 in the housing 17 near the ejection edge 21, as shown in FIGS. 2 and 3, and providing the lip 20 with bearing pins that mate therewith. A locking device 41 retains the lip 20 in the adjusted position, thereby adjusting the blow nozzle 22 as well. This makes it possible to adjust the lip 20 exactly in the plane that extends in the direction of the line of intersection between the plane A-B and the conveyor belt 24, as shown in FIG. 1.

When the ejection lip 20 is in the illustrated position, the alignment thereof with the conveyor belt 24 and the support by the outflow in the same direction will result in an orientation of the fibres in the direction of the plane A-B, with the fibres extending substantially perpendicularly to the horizontal supporting surface of the conveyor belt 24 on which the fibre structure is being formed.

On the conveyor belt 24, polyurethane foam granules are spread over the fibre structure by means of a spreading device 30. Because of the vertical orientation of the fibres, the granules will fall between the fibres. The spreading device 30 comprises a supply belt 31, which runs over two rollers 32, 33, and a distributing comb 34, which vibrates forward and backward so as to evenly distribute the granules being supplied via the belt 31 over the belt. The supply belt 31 has the same width as the conveyor belt 24. At the end of the conveyor belt 31, near the roller 32, the granules fall from the belt 31 onto the fibre structure that is present on the conveyor belt 24 that is disposed therebelow.

The fibre structure that is formed in this manner is subsequently carried to a second, identical device for the next production step. Alternatively, the fibre structure may be carried to the same device a second time.

In this next production step, the lip 20 has been pivoted downwards about the ejection edge 21, so that it now lies in a plane substantially contiguous to the ejection edge 21, as shown in FIG. 3. As a result, the fibres are placed on the conveyor belt 24 at a position upstream of the plane A-B after being carried through the chute 1 and the passage between the pick-up roller 16 and the housing 17, and they are pushed substantially flat against the conveyor belt 24.

The pressure roller 26 above the conveyor belt 24 is vertically adjustable in the direction of the conveyor belt 24, as is shown in FIG. 3, so that it is possible to adjust the height and the position in the longitudinal direction of the passage in the plane A-B that is formed with the conveyor belt. The pressure roller 26 is adjusted in downward direction for the second production step, so that the fibres in the fibre structure are pressed together in their flat orientation. In this way the fibre structure is converted into a blanket consisting of fibres and polyurethane granules, which blanket has a high fibre density.

The blanket formed in this manner is subsequently carried to a furnace device, where the fibres and the polyurethane granules are heated to a temperature of 151° C., so that the outer copolymer layer of the fibres as well as the grains will melt and fuse together to a certain degree. The heating temperature depends on the melt index of the synthetic fibres, amongst other factors, and consequently it may vary between 124° C. and 180° C., depending on the composition of the fibres. Preferably, the blanket is passed between two pressure rollers in the furnace, with the spacing between the two pressure rollers being adjustable. In this way a proper bond is obtained and any loss of granules from the blanket during use is prevented. By varying the spacing between the pressure rollers it is possible to obtain blankets having different densities for different applications.

FIG. 4 shows an alternative embodiment of the device, in which a blow nozzle 50 is provided that can pivot independently of the lip 20 via pins 52 and bearings 51 present on either side of the housing 17. This makes it possible to adjust the angle at which the fibre material is ejected with respect to the conveyor belt 24, whilst the direction of the air flow can be adjusted independently thereof, which has a major effect on the desired orientation of the fibres when the fibre structure is being formed.

1. A method for manufacturing an oil absorbent blanket, wherein particles having a high oil absorption capacity are incorporated in a fibre structure, the blanket being a nonwoven blanket manufactured by the method comprising:
arranging the fibres in a flat structure, in which the fibres extend substantially perpendicularly to the plane of the structure;
adding the oil absorbent particles to the fibre material;
rotating the fibres from the aforesaid perpendicular direction to a direction substantially parallel to the plane of the structure; and
compressing the fibre structure, so that a coherent blanket is obtained.

2. A method according to claim 1, wherein the granules are made of polyurethane foam.

3. A method according to claim 1, wherein the granules have a diameter of 1-4 mm.

4. A method according to claim 1, wherein the fibres are at least partially made of a synthetic material.

5. A method according to claim 4, wherein the outer side of the fibres has a lower melting point than the core of the fibres.

6. A method according to claim 4, wherein the fibres are made of polypropylene.

7. A method according to claim 4, wherein the outer side of the fibres is made of copolymer polypropylene.

8. A method according to claim 1, wherein the fibres have a length of 20-80 mm.

9. A method according to claim 1, wherein the blanket is heated during or after compression of the fibre structure, causing the outer side of at least one of the fibres and the granules to melt at least partially, to such an extent that the granules will adhere to the fibres.

10. An oil absorbent blanket manufactured by the method according to claim 1.

11. A method according to claim 2, wherein the granules have a diameter of 1-4 mm.

12. A method according to claim 2, wherein the fibres are at least partially made of a synthetic material.

13. A method according to claim 3, wherein the fibres are at least partially made of a synthetic material.

14. A method according to claim 5, wherein the fibres are made of polypropylene.

15. A method according to claim 5, wherein the outer side of the fibres is made of copolymer polypropylene.

16. A method according to claim 6, wherein the outer side of the fibres is made of copolymer polypropylene.

17. A method according to claim 8, wherein the fibres have a length of 40-60 mm.
